(19) United States
(12) Patent Application Publication
(10) Pub. No.: US 2017/0175052 A1
(43) Pub. Date: Jun. 22, 2017

(54) PROCESS TO MANUFACTURE AN EXTERNALLY STRUCTURED ISOTROPIC AQUEOUS DETERGENT LIQUID

(71) Applicant: Conopco, Inc., d/b/a UNILEVER, Englewood Cliffs, NJ (US)

(72) Inventors: Jane HOWARD, Wallasey (GB); Jayne Victoria RICE, Prenton (GB); Jeremy Robert WESTWELL, Tarporley (GB)

(73) Assignee: Conopco, Inc., d/b/a UNILEVER, Englewood Cliffs, NJ (US)

(21) Appl. No.: 15/129,476

(22) PCT Filed: Apr. 9, 2015
(86) PCT No.: PCT/EP2015/057715

§ 371 Date: Sep. 27, 2016

(30) Foreign Application Priority Data
Apr. 10, 2014 (EP) 14164140.7

(51) Int. Cl. C11D 3/50; C11D 1/83; C11D 3/22; C11D 1/29; C11D 17/00; C11D 3/37; C11D 3/382; C11D 1/22

(52) U.S. Cl. CPC C11D 3/505; C11D 3/382; C11D 1/83; C11D 1/22; C11D 1/29; C11D 17/0039; C11D 17/0013; C11D 3/3723; C11D 3/222

(57) ABSTRACT

The present invention relates to a process of incorporating charged microcapsules into a structured aqueous liquid detergent comprising: total surfactant in the range 3 weight % to 70 weight %, wherein the total surfactant comprises at least 5 weight anionic surfactant; at least 0.05% activated citrus fibre external structurant and at least 0.001 weight % microcapsules, the process comprising the step of combining two premixes A and B to form the liquid detergent; wherein Premix B comprises the structured aqueous concentrated liquid detergent formulation in the absence of the microcapsules; and Premix A comprises an aqueous dispersion of the charged microcapsules characterised in that Premix A comprises a slurry of charged microcapsules diluted with at least an equal weight of water; and wherein the structured aqueous concentrated liquid detergent comprises less than 5% agglomerated groups of microcapsules, based on the total number of groups of microcapsules, wherein an agglomerated group of microcapsules comprises more than five microcapsules grouped together.

### TECHNICAL FIELD OF THE INVENTION

The present invention relates to a process of incorporating microcapsules into an externally structured isotropic aqueous detergent liquid. More specifically, the present invention relates to an improved process of incorporating microcapsules into an externally structured isotropic aqueous detergent liquid to manufacture an externally structured isotropic aqueous detergent liquid with a substantially homogenous dispersion of encapsulated fragrance microcapsules.

### BACKGROUND OF THE INVENTION

Isotropic liquid detergent formulations have no innate ability to suspend solid particles, for example cues and microcapsules (also known as encapsulates). Whilst it is possible to obtain a suspending medium by appropriate manipulation of surfactant and electrolyte levels in a detergent formulation, such processes impose undesirable constraints on the formulation. This has lead to the use of so-called ‘external structurants’, through which it is now possible to achieve the required suspending duty without imposing limiting constraints on the levels of the components in the detergent formulation.

The term ‘external’ used herein in relation to structurants refer to reagents which may be added to a formulation whilst maintaining the desired fluid properties of a detergent liquid. This is in contrast to ‘internal’ structurants which structure detergent liquids from within using for example electrolytes or salts, and which lead to the formation of a lamellar phase or “gel” which suspend solid particles. Whilst the use of internal structurants may be a cost effective way of creating suspending properties for particles within a detergent, such formulations often possess a viscosity which is too high, resulting in the need for rheology modifiers. Consequently, it is often preferred to use reagents which may be added to a formulation “externally” whilst maintaining the fluid properties.

There are numerous structurants employed in detergent applications. One example of an external structurant is citrus fibre. Formulations comprising citrus fibre and the use of same in foodstuffs and personal care formulations are described in US2004/0086626 and US2009/269376.

In addition, the compatibility of an activated citrus fibre structured liquid detergent formulation with cleaning and care enzymes is described in PCT/EP2011/067549.

Another known system for suspending solid particles is a combination of clay and a rheology modifying polymer, as disclosed in EP1402877 (Rohm and Haas) and Research Disclosure, June 2000, No. 434, pages 1032-1033.

The use of microcapsules in liquid detergents is also well known. Microcapsules traditionally consist of a shell which surrounds and protects an inner core and the contents held therein. Microcapsules have been designed to provide a delayed release of their contents and/or, which provide a stable formulation for their contents until required, when the contents would otherwise interact with for example bulk liquid.

Microcapsules of this type are commonplace in the detergents field, including aqueous liquid detergent formulations. It is desirable that the microcapsules are small enough to be usable in large numbers, and are generally not visible by eye when introduced into a liquid detergent. For example, perfume encapsulates with melamine formaldehyde shells as described in U.S. Pat. No. 5,066,419. Alternatively, the microcapsules may contain liquid fabric treatment additives such as shading dyes, lubricants etc.

Whilst some microcapsules may be suspended in an unmodified liquid, others with less closely matched specific gravity may require modification of the liquid using for example, a thickening or structuring system in order to avoid creaming or settling of the microcapsules. Nevertheless, the use of microcapsules may cause the liquid to become hazy and may lead to undesirable agglomeration of the microcapsules.

For example, when perfume microcapsules are added to concentrated surfactant formulations in the form of a concentrated slurry, especially surfactant formulations comprising an external structurant, (such as citrus pulp and clay) the microcapsules have been found to undergo undesirable agglomeration into clumps when incorporated into the detergent formulation. If fragrance encapsulates are not evenly dispersed in the detergent liquid then there is a tendency for the encapsulated agglomerates to deposit in clumps onto fabric during the washing process. This leads to an uneven distribution and dosing of encapsulates; potential damage to encapsulates and thus an ineffective delivery of fragrance to the fabric. It may also lead to fabric damage and the need to use more microcapsules than would otherwise be necessary. Agglomeration also increases the chances of the microcapsules being accidently removed from the fabric, potentially resulting in an undesirable loss of fragrance from the fabric before or during wear.

For example, in WO 2009/135765A there is disclosed a process for the manufacture of a structured liquid detergent formulation comprising: a disperse-phase benefit agent which may be a perfume microcapsule, micro-fibrous cellulose structurant, at least 5 weight % anionic surfactant and 25 to 55 weight % surfactant. The process comprises the steps of (i) preparing a micro-fibrous cellulose premix using high shear mixing; and (ii) separate preparation of an aqueous surfactant mix, followed by a combination of the micro-fibrous cellulose premix and the surfactant mix using high shear mixing. The perfume microcapsules may then be post-dosed to the resulting structured concentrated surfactant structured liquid.

The high shear mixing step is achieved using an inline mixing process, such as by contacting the two process streams directly before an in-line mixer. Microcapsule particle sizes are in the range of 5 to 50 microns, preferably 10 to 30 microns. Example 4 of WO 2009/135765A discloses details of perfume microcapsule addition in which 1.5 weight % perfume encapsulates were added to a micro-fibrous cellulose structured liquid with a surfactant level of 40 to 50 weight %. Addition of the perfume microcapsules was performed over 30 seconds, using a Heidolph stirrer, with mixing continued for 5 minutes (as required). A Heidolph laboratory mixer is an overhead driven propeller or paddle stirrer. It is not a static in-line mixer. There is no disclosure in WO 2009/135765A however of how to specifically add perfume microcapsules to a liquid detergent formulation and avoid agglomeration.

In US 2008/0105441, there is disclosed a method of making a thickened detergent liquid by adding surfactant to a pre-mix of micro-fibrous cellulose structurant and water followed by subsequently adding particulates. However, there is no disclosure in US 2008/0105441 of any required treatment of the particulates.

WO 2011/054389 discloses a laundry detergent formulation and a method of preparing same comprising from 5 to 80 weight % of an anionic and/or nonionic surfactant; and from 0.001 to 5 weight % of micro-fibrous cellulose; and from 0.025 to 10 weight % of perfume particles with the proviso that when the perfume particles are present at a level of 1.5 weight % and have a polymeric melamine-formaldehyde shell, then the perfume particles additionally comprise a deposition aid. Also disclosed is the use of micro-fibrous cellulose to increase the deposition of perfume particles and a method of treating textiles with the formulation. There is no specific disclosure in WO 2011/054389 however of how perfume particles should be prepared or pre-treated prior to addition to the detergent formulation.

WO 2011/120772A describes a process for the incorporation of microcapsules with anionic charge into a structured aqueous concentrated liquid detergent comprising at least 30 weight %, total surfactant of which at least 5 weight % based on the total formulation is anionic surfactant, including soap, and hydrogenated castor oil as an external structurant. The process comprises combining two premixes; Premix A which is a structured aqueous concentrated liquid detergent formulation without microcapsules and Premix B which comprises an aqueous dispersion of the microcapsules with anionic charge. Premix B consists of a slurry of microcapsules with a maximum viscosity at 25° C., 100 mPas, and at least 90 weight % of the microcapsules have a particle size in the range 5 to 30 microns. When Premix B is added to Premix A agglomeration of the microcapsules occurs. It is then necessary to disperse and break-up the agglomerates by pumping the resulting combined mixture through a static in-line mixer with an energy input of from 20 to 500 J/kg to form a structured liquid comprising less than 10% agglomerated groups of microcapsules, based on the total number of groups of microcapsules. An agglomerated group of microcapsules being defined as a group having more than 5 microcapsules grouped together.

US 2012/0208737, US 2011/257070 and WO 2009/101545 disclose a structured liquid detergent formulation, and a process for preparing same, in the form of a liquid matrix made up of an external structuring system of a bacterial cellulose network; water; and surfactant system including an anionic surfactant; a nonionic surfactant; a cationic surfactant; an ampholytic surfactant; a zwitterionic surfactant; or mixtures thereof, wherein said liquid matrix has a yield stress of from about 0.003 Pa to about 5.0 Pa at about 25° C., and provides suitable particle suspension capabilities and shear thinning characteristics. However, these documents provide no details regarding pre-treatment of the particles to ensure adequate suspension.

Therefore, as microcapsules and fragranced encapsulates in particular are prone to damage, especially when agglomerated, and especially when dry, the incorporation of fragranced encapsulates into a liquid detergent formulation at the required concentration and without agglomeration is a difficult but essential process for detergent formulators.

The present invention therefore seeks to provide an improved process of manufacturing an externally structured aqueous detergent liquid comprising a substantially homogenous dispersion of encapsulated fragrance microcapsules which overcomes or at least mitigates agglomeration of the microcapsules.

That is, it is therefore an object of the present invention to provide an improved process of manufacturing an externally structured aqueous detergent liquid which seeks to address or at least mitigate substantial agglomeration of microcapsules, especially agglomeration of encapsulated fragrance microcapsules in an externally structured isotropic aqueous detergent formulation.

### SUMMARY OF THE INVENTION

Therefore according to a first aspect of the present invention there is provided a process of manufacturing a structured isotropic aqueous detergent liquid, incorporating microcapsules, the detergent liquid comprising:
i) total surfactant in the range 3 weight % to 70 weight %, and wherein the total surfactant comprises at least 5 weight % anionic surfactant; and
ii) at least 0.05% activated citrus fibre external structurant;
iii) at least 0.001 weight % microcapsules;
   the process comprising a step of combining two premixes A and B; wherein
   a) Premix A comprises an aqueous dispersion of microcapsules; and
   b) Premix B comprises the structured aqueous concentrated liquid detergent formulation in the absence of microcapsules, characterised in that:

Premix A comprises:
a slurry of microcapsules diluted with at least at an equal weight of water; and
wherein at least 90 weight % of the microcapsules comprise a particle size in the range 5 to 30 microns; and
wherein Premix A is agitated with stirring to disperse the microcapsules prior to the addition of Premix A to Premix B; and wherein
the structured aqueous concentrated liquid detergent comprises less than 5% agglomerated groups of microcapsules, based on the total number of groups of microcapsules, wherein an agglomerated group of microcapsules comprises more than five microcapsules grouped together.

The process of the present invention is preferably applied to concentrated structured isotropic aqueous liquid detergents, that is, detergents with a reduced volume of water.

The water used in the process of the present invention may comprise demineralised water. Alternatively, the water used in the process of the present invention may comprise demineralised water and/or water derived from other reagents in the formulation as supplied.

The microcapsules used in the process of the present invention may be charged. More specifically, the microcapsules used in the process of the present invention may comprise an anionic charge. Alternatively, the microcapsules used in the process of the present invention may comprise a cationic charge. Most preferably, the microcapsules comprise an anionic charge.

Furthermore, in the process according to the present invention the aqueous dispersion of microcapsules in water may be added to the structured aqueous concentrated liquid detergent before the addition of all other components of the liquid detergent.

Alternatively, in the process according to the present invention the aqueous dispersion of microcapsules in water may be added to the structured aqueous concentrated liquid detergent after addition of all other components of the liquid detergent.

However, it is preferred that the aqueous dispersion of microcapsules in water is added to the structured aqueous concentrated liquid detergent before the addition of all other components of the liquid detergent.

That is, Premix A comprising a concentrated encapsulated slurry is added upfront in the formulation demineralised water (necessary to make the formulation up to 100% of a formulation detergent mix) and mixed preferably for between 2 and 10 minutes; more preferably for between 4 and 6 minutes; and most preferably for 5 minutes at between 250 and 350 rpm; most preferably at 300 rpm. This diluted pre-dispersion of Premix A then has all other ingredients of the detergent formulation such as for example, external structurant citrus pulp fibre premix, clay and surfactants added to Premix A to produce a final formulation.

It may also be preferred to pass the combined formulation of Premix A and B through a rotar stator dynamic mixer to form a fully structured detergent formulation.

The aqueous dispersion of microcapsules may comprise a 1:1 ratio by weight of microcapsule slurry to water. Alternatively, the aqueous dispersion of microcapsules may comprise a 1:3 ratio of microcapsule slurry to water. Most preferably however, the aqueous dispersion of microcapsules comprises a 1:3 ratio of microcapsule slurry to water.

Also in relation to the process of the present invention preferably, Premix B is milled with an energy input of from 1.2 to 5.0 KJ/kg prior to mixing with Premix A to form the structured aqueous concentrated liquid detergent.

Alternatively, Premix A is combined with Premix B and the two Premixes milled with an energy input of from 1.2 to 5.0 KJ/kg to form the structured aqueous concentrated liquid detergent.

Furthermore, the microcapsules used in the process of the present invention comprise a shell comprising a material selected from the group consisting of: (poly)urea, (poly)urethane, polysaccharide, starch, aminoplasts or a melamine formaldehyde shell. Most preferably, the microcapsules used in the process of the present invention comprise a melamine formaldehyde shell.

In addition, in the process according to the present invention, the microcapsules may further possess a deposition aid, most preferably located on the outside of the microcapsule shell. The deposition aid may be selected from cellulose derivatives and polyesters. Particularly preferred polysaccharide additional deposition aids include: dextran, hydroxy-propyl methyl cellulose, hydroxy-ethyl methyl cellulose, hydroxy-propyl guar, hydroxy-ethyl ethyl cellulose, methyl cellulose, locust bean gum, xyloglucan, guar gum. Particularly preferred polyester additional deposition aids include: polymers having one or more nonionic hydrophilic components comprising oxyethylene, polyoxyethylene, oxypropylene or polyoxypropylene segments, and, one or more hydrophobic components comprising terephthalate segments.

It is also preferred that in relation to the process of the present invention the microcapsules are perfume encapsulates.

Therefore, whilst current processes for preparing liquid detergent formulations suffer from agglomeration of microcapsules when added as a concentrated slurry at the end of the formulation process, (fragrances and other benefit ingredients being typically added at the end of batch making when temperatures are cooler) the present invention has demonstrated that by pre-dispersing encapsulated fragrance slurry in the form of microcapsules in water, before adding to the detergent formulation, agglomeration is avoided.

The inventors have therefore found that pre-dispersion of the microcapsules offers improved flexibility in terms of preparing the liquid detergent formulations. That is, the pre-dispersion of the microcapsules provides the ability to add encapsulates either ‘up-front’ at start of the formulation process or alternatively, after the main ingredients have been added to the formulation, and either before or after milling of the formulation.

However, it is most preferred that in the process of preparing a detergent formulation according to the present invention, the microcapsules are added as a concentrated slurry, at the start of the formulation process, preferably with batch water and that all other detergent ingredients are then added to this pre-dispersed mixture.

Detergent Formulations

1. Activated Citrus Fibre

Citrus fruits (mainly lemons and limes) may be de-juiced to leave an insoluble plant cell wall material with some internally contained sugars and pectin. The ‘spongy microstructure’, known as albedo, may be used to make acidic, powdered citrus fibre. The structure is dried, sieved and then washed to increase the fibre content. Dried materials are typically large (with cell fragments greater than 100 microns), consisting of tightly bound/bonded fibrils). After milling a powdered citrus fibre material is obtained. This procedure leaves much of the natural cell wall intact whilst sugars are removed. The resultant swellable citrus fibre materials are typically used as food additives and are often employed for example in low fat mayonnaise.

Microscopy shows that powdered citrus fibre is a heterogeneous mixture of particles with various sizes and shapes. The majority of the material consists of aggregated lumps of cell walls and cell wall debris. However, a number of tube-like structures with an open diameter of about 10 micron, often arranged in clusters, may be identified. These, so called, xylem vessels are water transport channels that are mainly located in the peel of citrus fruits. The xylem vessels consist of stacks of dead cells, joined together to form relatively long tubes, 200 to 300 micron long. The outsides of the tubes are reinforced by lignin, which is often laid down in rings or helices, preventing the tubes from collapse due to the capillary forces acting on the tube walls during water transport.

A preferred type of powdered citrus fibre for detergent formulations and used in accordance with the present invention is available from Herbafoods under the tradename, Herbacel™ AQ+ type N citrus fibre. This citrus fibre has a total (soluble and insoluble) fibre content of greater than 80% by weight and soluble fibre content of greater than 20% by weight. It is supplied as a fine dried powder with low colour and has a water binding capacity of about 20 kg water per kg of powder.

To obtain adequate structure in the premix of the present invention, powdered citrus fibre is activated (hydrated and opened up structurally) using a high shear dispersion process at low concentration, in water. It is also advantageous to include a preservative into the premix as the dispersed activated citrus fibre is biodegradable.

It is desirable that the shear applied to the citrus fibre should not be so high as to lead to defibrillation. Consequently, if a high-pressure homogeniser is used, it is preferably operated between 50 and 1000 barg. More preferably if a high-pressure homogeniser is used it is preferably operated between 100 and 700 barg. Most preferably the high-pressure homogeniser is activated between 300 and 500 barg. The more shear that is applied the less dense the resulting particles. Whilst the morphology is changed by the high shear, process aggregate size appears not to be changed and instead, fibres breakdown and then fill the water. The shearing process also loosens the outer parts of the fruit cell walls and these are able to form a matrix that structures the water outside the volume of the original fibre.

The level of activated citrus fibre in a premix prepared in accordance with the present invention preferably lies in the range of 0.2 to 6 weight %. More preferably the level of activated citrus fibre in a premix prepared in accordance with the present invention preferably lies in the range of 0.5 to 4 weight %. Most preferably the level of activated citrus fibre in a premix prepared in accordance with the present invention preferably lies in the range of 1 to 3 weight %.

The level of citrus pulp premix inclusion levels in actual liquid detergent is preferably in the range 0.01% to 2 weight %. More preferably the level of citrus pulp premix inclusion levels in actual detergent is 0.05% to 0.5%. Most preferably level of citrus pulp premix inclusion levels in actual detergent is 0.04% to 0.3 weight % in formulation.

It will however be apparent to a skilled reader that the concentration of activated citrus fibre in the pre-mix depends on the ability of the equipment to deal with the higher viscosity especially at higher concentrations.

Preferably the amount of water in the premix is at least 20 times greater than the amount of citrus fibres. More preferably the amount of water in the premix is at least at least 25 times the amount of citrus fibres. Even more preferably the amount of water in the premix is as much as 50 times the amount of citrus fibres. It is also advantageous that there is excess water in order to hydrate the activated citrus fibre fully. Preferred premixes have a measured yield stress of at least 15 Pa measured using an Anton Paar serrated cup and bob geometry at 25° C.

A preferred yield stress range for activated citrus pulp is typically 50 to 250 Pa. More preferably the yield stress range for activated citrus pulp is 70 to 200 Pa. Most preferably, the yields stress range for activated citrus pulp is 80 to 180 Pa.

When added to a liquid detergent formulation activated citrus fibre boosts the yield stress and the pour viscosity of the formulation at 21^{s-1} and the formulation is referred to as a shear thinning liquid. Yield stress and viscosity at 21^{s-1} increase generally in line with the level of activated citrus fibre.

Activated citrus fibre has the further advantage that it is compatible with enzymes used in laundry and household care detergent formulations.

If required, during processing of the formulation air may be removed using a de-aerator.

A citrus fibre and water premix in accordance with the present invention may be prepared by milling using a high shear mixer, such as a rotor stator mixer. The premix of citrus fibre may be passed through several high shear stages in order to ensure full hydration and dispersal of the citrus fibre to from the activated citrus fibre dispersion. The premix may be left to hydrate further (also known as aging) after the high shear dispersal. It is preferred however, that the activated premix is used whilst fresh, especially as the premix is in liquid format, leading to an increased problem of microbial activity with time if the premix is not used within a few hours.

High pressure homogenised premixes are preferred over milled premixes, as the former are more weight effective and provide sufficient suspending duty to liquids. Furthermore, increasing the homogenisation pressure provides further increased weight efficiency to the premix. A suitable operational pressure is in the region of 500 barg.

The citrus pulp premix prepared in accordance with the present invention may be added to a detergent liquid formulation as a post-dosed ingredient. However, it is preferred that the detergent liquid formulation is formed by starting with the water and citrus pulp premix prepared in accordance with the present invention followed by the addition of other ingredients as required. Some high shear is required to disperse the premix in the detergent formulation fully but the duty is not as demanding as for the premix preparation.

It is desirable to use the activated citrus fibre at a high enough level to ensure that the external structuring network does not settle under its own weight.

2. Water

The detergent liquid formulations prepared in accordance with the present invention are aqueous and water forms the majority of the formulation. Hydrotropes such as propylene glycol and glycerol/glycerine may also be included as co-solvents to a lesser extent than water. Water is required in the formulation in order to keep other components of the formulation such as for example, surfactants, polymers, soluble builders, enzymes etc in solution. The water referred to in the formulation includes both free water, which is preferably demineralised water and also any ‘bound’ water, arising from the inclusion of components which are themselves supplied in water/demineralised water. The amount of water in the formulation is preferably at least 20 weight %. More preferably the amount of water in the formulation is at least 30 weight %. Most preferably however, the amount of water in the formulation is at least 40%.

3. Mixed Surfactant System

The use of activated citrus fibre as external structurant means that there are few limitations on the type or the amount of mixed surfactant system which may be employed in the detergent liquid formulation. However, synthetic surfactants preferably form a major part of the surfactant system. Mixtures of synthetic anionic and nonionic surfactants, or a wholly anionic mixed surfactant system or admixtures of anionic surfactants, nonionic surfactants and amphoteric or zwitterionic surfactants may all be used according to the choice of the formulator for the required cleaning duty and the required dose of the liquid detergent formulation.

In addition, the surfactants forming the mixed surfactant system may be chosen from the surfactants described in ‘Surface Active Agents’ Vol. 1, by Schwartz & Perry, Interscience 1949, Vol. 2 by Schwartz, Perry & Berch, Interscience 1958, ‘McCutcheon's Emulsifiers and Detergents’ published by Manufacturing Confectioners Company or in ‘Tenside Taschenbuch’, H. Stache, 2nd Edn., Carl Hauser Verlag, 1981.

The amount of surfactant in the formulation may range from 3 to 70 weight %. Alternatively, the amount of surfactant in the formulation may range from 4 to 60 weight %. More preferably the amount of surfactant in the formulation may range from 6 to 50 weight % or even in the range 10 to 40 weight %. Most preferably the total surfactant may be in the range 20 to 30 weight %. It will also be appreciated by the skilled addressee that the optimum surfactant concentration will largely depend on the product type and the intended mode of use.

The anionic surfactant may also further include soap (that is, a salt of fatty acid). A preferred soap employed in detergent formulations according to the present invention is made by neutralisation of hydrogenated coconut fatty acid, for example Prifac® 5908 (ex Croda). Mixtures of saturated and unsaturated fatty acids may also be used.

Nonionic detergent surfactants are well-known in the art. A preferred nonionic surfactant is a C₁₂-C₁₈ ethoxylated alcohol, comprising 3 to 9 ethylene oxide units per molecule. More preferred are C₁₂-C₁₅ primary, linear ethoxylated alcohols with on average between 5 and 9 ethylene oxide groups. More preferably, linear ethoxylated alcohols with an average of 7 ethylene oxide groups are employed.

Examples of suitable synthetic anionic surfactants include: sodium lauryl sulphate, sodium lauryl ether sulphate, ammonium lauryl sulphosuccinate, ammonium lauryl sulphate, ammonium lauryl ether sulphate, sodium cocoyl isethionate, sodium lauroyl isethionate, and sodium N-lauryl sarcosinate. Mostly preferably, the synthetic anionic surfactants comprise synthetic anionic surfactant linear alkylbenzene sulphonate (LAS) or another synthetic anionic surfactant sodium alcohol ethoxy-ether sulphate (SAES), most preferably comprising high levels of sodium C₁₂ alcohol ethoxy-ether sulphate (SLES). It is preferred that the detergent liquid formulation prepared according to the present invention comprises LAS.

A preferred mixed surfactant system comprises synthetic anionic with nonionic detergent active materials and optionally amphoteric surfactant, including amine oxide.

Another preferred mixed surfactant system comprises two different anionic surfactants, preferably linear alkyl benzene sulphonate and a sulphate, for example LAS and SLES.

Synthetic anionic surfactants may be present, for example, in amounts in the range from about 5% to about 70 weight % of the mixed surfactant system. More preferably, anionic surfactants may be present between 5% to 40 weight %. Most preferably anionic surfactants may be present between 10% to 30 weight %.

The liquid detergent formulations may further comprise an amphoteric surfactant, wherein the amphoteric surfactant is present in a concentration of 1 to 20 weight %. Preferably the liquid detergent formulations comprise an amphoteric surfactant present in a concentration of 2 to 15 weight %. More preferably the liquid detergent formulations comprise an amphoteric surfactant present in a concentration of 3 to 12 weight % of the mixed surfactant system. Typical examples of suitable amphoteric and zwitterionic surfactants include: alkyl betaines, alkylamido betaines, amine oxides, aminopropionates, aminoglycinates, amphoteric imidazolinium compounds, alkyldimethylbetaines or alkyldipolyethoxybetaines.

4. Suspended Non-Clay Particles/Microcapsules.

The formulation prepared in accordance with the present invention comprises suspended non-clay particles. These particles are preferably solid; that is to say they are neither liquid nor gas. However, within the term solid we include particles with either rigid or deformable solid shells which may then contain fluids. For example the solid particles may be microcapsules such as perfume encapsulates (encaps), or care additives in encapsulated form. The particles may take the form of insoluble ingredients such as silicones, quaternary ammonium materials, insoluble polymers, insoluble optical brighteners and other known benefit agents as described, for example, in EP1328616. The amount of suspended particles in the liquid detergent formulation may be from 0.001 to up to 2 weight %. The amount of suspended particles in the liquid detergent may also be up to 5 weight % or even 10 weight %. In some circumstances the suspended particles in the liquid detergent formulation may be up to 20 weight %.

The average particle diameter of the microcapsules lies in the range from 1 to 100 micrometer and at least 90 weight % of the microcapsules preferably possess a diameter in this range. More preferably, 90 weight % of the microcapsules have a diameter in the range 2 to 50 micrometers, even more preferably 5 to 50 micrometers. Most preferred are microcapsules with diameters from 5 to 30 micrometers.

It is advantageous to have a very narrow particle size distribution, for instance 90 weight % of microcapsules in the range 8 to 11 microns. Microcapsules in the range 2 to 5 microns cannot be dispersed so effectively due to the high surface area of the smaller particles.

Preferably the formulation comprises at least 0.01 weight % of microcapsules, preferably with an anionic charge. Such microcapsules may deliver a variety of benefit agents by deposition onto substrates such as laundry fabric. To obtain maximum benefit they should be well dispersed through the liquid detergent formulation and the vast majority of the microcapsules must not be significantly agglomerated. Any microcapsules that become agglomerated during manufacture of the liquid remain so in the container and will thus be dispensed unevenly during use of the formulation. This is highly undesirable. The contents of the microcapsules are normally liquid. For example, fragrances, oils, fabric softening additives and fabric care additives are possible contents. Preferred microcapsules are particles termed core-in-shell microcapsules. As used herein, the term core-in-shell microcapsules refers to encapsulates whereby a shell which is substantially or totally water-insoluble at 40° C. surrounds a core which comprises or consists of a benefit agent (which is either liquid or dispersed in a liquid carrier).

Suitable microcapsules are those described in U.S. Pat. No. 5,066,419 which have a friable coating, preferably an aminoplast polymer. Preferably, the coating is the reaction product of an amine selected from urea and melamine, or mixtures thereof, and an aldehyde selected from formaldehyde, acetaldehyde, glutaraldehyde or mixtures thereof. Preferably, the coating is from 1 to 30 weight % of the particles. Other suitable shell material may be selected from but not limited to: (poly)urea, (poly)urethane, starch/polysaccharide, xyloglucan and aminoplasts.

Core-in-shell microcapsules of other kinds are also suitable for use in the present invention. Ways of making such other microcapsules benefit agents such as perfume include precipitation and deposition of polymers at the interface such as in coacervates, as disclosed in GB-A-751 600, U.S. Pat. No. 3,341,466 and EP-A-385 534, as well as other polymerisation routes such as interfacial condensation, as described in U.S. Pat. No. 3,577,515, US-A-2003/0125222, U.S. Pat. No. 6,020,066 and WO-A-03/101606.

Microcapsules having polyurea walls are disclosed in U.S. Pat. No. 6,797,670 and U.S. Pat. No. 6,586,107. Other patent applications specifically relating to use of melamine-formaldehyde core-in-shell microcapsules in aqueous liquids are WO-A-98/28396, WO02/074430, EP-A-1 244 768, US-A-2004/0071746 and US-A-2004/0142868.

Perfume encapsulates are a preferred type of microcapsule suitable for use in the process of the present invention.

A preferred class of core-in-shell perfume microcapsule comprises those disclosed in WO 2006/066654 A1. These comprise a core having from about 5% to about 50 weight % of perfume dispersed in from about 95% to about 50 weight % of a carrier material. This carrier material preferably is a non-polymeric solid fatty alcohol or fatty ester carrier material, or mixtures thereof. Preferably, the esters or alcohols have a molecular weight of from about 100 to about 500 and a melting point from about 37° C. to about 80° C., and are substantially water-insoluble. The core comprising the perfume and the carrier material are coated in a substantially water-insoluble coating on their outer surfaces. Similar microcapsules are disclosed in U.S. Pat. No. 5,154,842 and these are also suitable.

The microcapsules may attach to suitable substrates, for example to provide persistent fragrance that is desirably released after the cleaning process is complete.

In order to deliver microcapsules comprising fragrance, often referred to as fragrance encapsulates (or “encaps”) to fabric, the microcapsules must be added to a fabric washing liquid. Since these microcapsules are less dense than an isotropic liquid phase, the microcapsules cannot be suspended in a Newtonian (non-structured fabric washing liquid as the microcapsules “cream” or float to the surface if placed in the fabric washing liquid.

The use of citrus pulp as external structurant has enabled the preparation of externally structured formulations which are able to suspend microcapsules such as ‘encaps’.

Fragrance containing microcapsules are often supplied as concentrated slurries which comprise the microcapsules containing free oil fragrance. Unfortunately the slurries cannot be added once the liquid formulation has been produced as the microcapsules tend to agglomerate. Agglomeration is a problem as this leads to uneven deposition of the microcapsules on fabric washed with the liquid formulation and the increases agglomeration also leads to the microcapsules being removed accidently from the washed fabric instead of remaining on the fabric to release fragrance when the fabric is used. It is therefore a requirement that microcapsules need to be efficiently and evenly dispersed in fabric washing liquid.

Another type of solid particle to be suspended is a visual cue, for example the type of flat film cue described in EP13119706, details of which are incorporated herein by reference. The cue may itself contain a segregated component of the detergent formulation. The cue must be water-soluble, yet insoluble in the formulation. It is therefore conveniently made from a modified polyvinyl alcohol that is insoluble in the presence of the mixed surfactant system. In which case, the liquid detergent formulation preferably comprises at least 5 weight % anionic surfactant.

The suspended non-clay particles or microcapsules may include for example benefit agents which are not limited to: perfume encapsulates, care encapsulates and/or visual cues or suspended solid opacifiers such as mica or other suspended pearlescent materials and mixtures of these materials. The closer the match of the density of the suspended particles to that of the detergent liquid, and the thicker the detergent liquid before addition of the external structurants the greater the amount of particles that may be suspended in the detergent formulation. Typically, up to 5 weight % of suspended particles may be suspended stably using citrus pulp as the external structurant, however, amounts up to 20 weight % are possible.

Silicas, amorphous silicates, crystalline nonlayer silicates, layer silicates, calcium carbonates, calcium/sodium carbonate double salts, sodium carbonates, sodalites, alkali metal phosphates, pectin, carboxyalkylcelluloses, gums, resins, gelatin, gum arabic, porous starches, modified starches, carboxyalkyl starches, cyclodextrins, maltodextrins, synthetic polymers such as polyvinyl pyrrolidone (PVP), polyvinyl alcohol (PVA), cellulose ethers, polystyrene, polyacrylates, polymethacrylates, polyolefins, aminoplast polymers, cross-linkers and mixtures thereof may all provide a basis for benefit agent delivery particles. Polymer particles are however preferred, especially polymer particles which comprise an aminoplast polymer.

Suspension is achieved by providing a yield stress. The yield stress needs to be larger than the stress imposed on the network by the microcapsules and/or cues otherwise the network is disrupted and the particles may sink or float depending on whether or not they are denser than the formulation. Microcapsules preferably comprise a solid shell. Microcapsules carrying an anionic charge or a cationic charge may also be used in the process of the present invention. However microcapsules carrying an anionic charge are preferred.

Deposition aids may also be present located on the surface of the microcapsules. These may advantageously be selected from non-ionic materials, preferably cellulose derivatives and polyesters and provide better substantivity to a plurality of substrates. Particularly preferred polysaccharide additional deposition aids include dextran, hydroxy-propyl methyl cellulose, hydroxy-ethyl methyl cellulose, hydroxy-propyl guar, hydroxy-ethyl ethyl cellulose, methyl cellulose, locust bean gum, xyloglucan, guar gum. Particularly preferred polyester additional deposition aids include polymers having one or more nonionic hydrophilic components comprising oxyethylene, polyoxyethylene, oxypropylene or polyoxypropylene segments, and, one or more hydrophobic components comprising terephthalate segments.

A representative process used for aminoplast encapsulation is disclosed in U.S. Pat. No. 3,516,941 though it is recognized that many variations with regard to materials and process steps are possible. A representative process used for gelatin encapsulation is disclosed in U.S. Pat. No. 2,800,457 though it is recognized that many variations with regard to materials and process steps are possible. Both of these processes are discussed in the context of fragrance encapsulation for use in consumer products in U.S. Pat. Nos. 4,145,184 and 5,112,688 respectively.

Particle and capsule diameter can vary from about 10 nanometers to about 1000 microns, preferably from about 50 nanometers to about 100 microns and most preferably from about 2 to about 15 microns. The capsule distribution may be narrow, broad, or multi-modal. Multi-modal distributions may be composed of different types of capsule chemistries.

Preferred benefit agents included fragrances, profragrance, clays, enzymes, antifoams, fluorescers, bleaching agents and precursors thereof (including photo-bleach), dyes and/or pigments, conditioning agents (for example cationic surfactants including water-insoluble quaternary ammonium materials, fatty alcohols and/or silicones), lubricants (e.g. sugar polyesters), colour and photo-protective agents (including sunscreens), antioxidants, ceramides, reducing agents, sequestrants, colour care additives (including dye fixing agents), unsaturated oil, emollients, moisturizers, insect repellents and/or pheromones, drape modifiers (e.g. polymer latex particles such as PVAc) and anti-microbial and microbe control agents. Mixtures of two or more of these may be employed.

In the process of the present invention perfume encapsulates are incorporated. Typical perfume components which it is advantageous to encapsulate, include those with a relatively low boiling point, preferably those with a boiling point of less than 300, preferably 100-250 Celsius.

It is also advantageous to encapsulate perfume components which have a low Log P (that is, those which will be partitioned into water), preferably with a Log P of less than 3.0.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian. By means of the present invention these materials can be transferred to textile articles that will be worn or otherwise come into contact with the human body (such as handkerchiefs and bed-linen).

The benefit agent may be encapsulated alone or co-encapsulated with carrier materials, further deposition aids and/or fixatives. Preferred materials to be co-encapsulated in carrier particles with the benefit agent include waxes, paraffins, stabilizers and fixatives.

Deposition Aids.

Once a fragrance material is encapsulated a cationically charged water-soluble polymer may be applied to the fragrance encapsulated polymer and/or a non-ionic deposition aid.

Non-Ionic Deposition

Polysaccharide Delivery Aid: Polysaccharide structures for the delivery aid are selected from but not limited to the group consisting of: poly-xyloglucan and poly-galactomannans other than Locust Bean Gum. Naturally-occurring polymer structures or the shorter hydrolysis products of naturally occurring polymer structures are particularly preferred. For example, preferred polysaccharide structures are those of tamarind xyloglucan, guar gum or mixtures thereof.

Xyloglucan has a backbone of beta 1, 4-linked glucose residues most of which are substituted with 1-6 linked xylose side chains. Galactomannans, have a beta 1,4-linked D-mannopyranose backbone with branch points from their 6-positions linked to alpha-D-galactose, that is, 1-6-linked alpha-D-galactopyranose). The polysaccharides of the present invention have a ratio of beta-1, 4 to 1, 6 linkages to other linkages of 0.5:1 to 3:1. The beta-1, 4 to 1, 6 ratio in Locust Bean Gum (that is, mannose to galactose) is around 4:1

5. Water Swellable Clay.

Suitable water swellable clays used in laundry applications are hydrous aluminium phylosilicates, sometimes with variable amounts of iron, magnesium, alkali metals, alkaline earths, and other cations. Clays form flat hexagonal sheets similar to the micas. Clays are ultrafine-grained (normally considered to be less than 2 micrometres in size on standard particle size classifications).

Clays are commonly referred to as 1:1 or 2:1. Clays are fundamentally built of tetrahedral sheets and octahedral sheets. A 1:1 clay consists of one tetrahedral sheet and one octahedral sheet, and examples include kaolinite and serpentine. A 2:1 clay consists of an octahedral sheet sandwiched between two tetrahedral sheets and examples are illite, smectite, and attapulgite.

The Smectite group includes dioctahedral smectites such as montmorillonite and nontronite and trioctahedral smectites for example saponite, as well as bentonite, pyrophylite, hectorite, sauconite, talc, beidellite. Other 2:1 clay types include sepiolite or attapulgite, clays with long water channels internal to their structure. Phylosilicates include: Halloysite, Kaolinite, Illite, Montmorillonite, Vermiculite, Talc, Palygorskite, Pyrophylite. Montmorillonite is a smectite phylosilicate (Na,Ca)_{0.33}(Al,Mg)₂(Si₄O₁₀)(OH)₂.nH₂O. Montmorillonite is a very soft phylosilicate group of minerals that typically form in microscopic crystals to form a clay.

Montmorillonite, is a 2:1 clay, meaning that it has 2 tetrahedral sheets sandwiching a central octahedral sheet. The particles are plate-shaped with an average diameter of approximately one micrometre. Montmorillonite is the main constituent of bentonite—a volcanic ash weathering product. Hectorite is a natural smectite clay with high silica content. Natural hectorite is a rare soft, greasy, white clay mineral.

Suitable water-swellable clays include: smectites, kaolins, ilites, chlorites and attapulgites. Specific examples of such clays include bentonite, pyrophylite, hectorite, saponite, sauconite, nontronite, talc and beidellite as smectite type clays. The water-swellable clay is preferably a smectite-type clay.

Montmorillonite clays, even in the presence of stabilising agents are sensitive to ionic strength. They lose their liquid structuring efficiency at high electrolyte levels normally present in many detergent formulations. Clays tend to collapse onto themselves or flocculate under these conditions. If this collapse occurs during storage the liquid will lose its physical stability, suffer syneresis and/or settling of solids.

The preferred water-swellable clay used in accordance with the present invention is a smectite-type clay, selected from the group consisting of Laponites, aluminium silicate, bentonite and fumed silica. Most preferred commercial synthetic hectorites are the Laponites from Rockwood. Particularly preferred synthetic hectorites are: Laponite S, Laponite RD, Laponite RDS, Laponite XLS and Laponite EL. Most preferred is Laponite EL. Laponite RD, XLG, D, EL, OG, and LV: are all lithium magnesium sodium silicates.

Other synthetic hectorite type clays include: Veegum Pro and Veegum F from RT Vanderbilt and the Barasymacaloids and Proaloids from Baroid division of National Lead Company.

Synthetic smectites are synthesised from a combination of metallic salts such as salts of sodium, magnesium and lithium with silicates, especially sodium silicates, at controlled ratios and temperature. This produces an amorphous precipitate which is then partially crystallised. The resultant product is then filtered washed dried and milled to give a powder containing platelets which have an average platelet size of less than 100 nm. Platelet size refers to the longest lineal dimension of a given platelet. Synthetic clay avoids the use of impurities found in natural clay.

Laponite is synthesised by combining salts of sodium magnesium and lithium with sodium silicate at carefully controlled rates and temperatures. This produces an amorphous precipitate which is then partially crystallised by a high temperature treatment. The resulting product is filtered, washed, dried and milled to a fine white powder.

The size of the clay is important. Thus the very fine synthetic hectorites are especially preferred because of their small particle size. Particle size is the size of a discreet grain of moistened clay. A suitable particle size is 0.001 to 1 micron, more preferably 0.005 to 0.5 micron and most preferably from 0.01 to 0.1 micron. The clay may be ground or crushed to bring the average size within the desired range.

Laponite has an average platelet size maximum dimension less than 100 nm. Laponite has a layer structure, which in dispersion in water, is in the form of disc-shaped crystals each being about 1 nm thickness and about 25 nm diameter. Small platelet size provides good sprayability, rheology and clarity. Preferably the clay has a particle size range in the colloidal range. Typically such clays provide a clear solution when they are hydrated, possibly because the clay particles do not scatter light when the clay is hydrated and exfoliates. Other larger clays will provide low shear viscosity build as required but the formulations will lack clarity.

Most preferred as the water swellable clay for use in the process and detergent formulations of the present invention is the synthetic clay supplied under the name Laponite EL from Rockwood. It combines a very small grain size with a tolerance to high ionic strength as found in detergent liquids. Laponite EL forms a dispersion in water and has a high surface charge. This is said to give it improved tolerance to electrolyte (including anionic surfactant). Laponite EL is available in both powder and sol forms. Either is suitable for use in the detergent liquid formulations.

Laponite has a layer structure which, in dispersion in water, is in the form of disc-shaped crystals. It can be envisaged as a two dimensional “inorganic polymer” where the empirical formula forms a unit cell in the crystal having six octahedral magnesium ions sandwiched between two layers of four tetrahedral silicon atoms. These groups are balanced by twenty oxygen atoms and four hydroxyl groups. The height of the unit cell represents the thickness of the Laponite crystal. The unit cell is repeated many times in two directions, resulting in the disc shaped appearance of the crystal. It has been estimated that a typical Laponite crystal contains up to 2000 of these unit cells. Macromolecules of this particle size are known as colloids. Natural clay mineral thickeners such as bentonite and hectorite have a similar disc shaped crystal structure but are more than one order of magnitude larger in size. The primary particle size of Laponite is much smaller than either natural hectorite or bentonite. The idealised structure would have a neutral charge with six divalent magnesium ions in the octahedral layer, giving a positive charge of twelve. In practice, however, some magnesium ions are substituted by lithium ions (monovalent) and some positions are empty. The clay has a negative charge of 0.7 per unit cell, which becomes neutralised during manufacture as sodium ions are adsorbed onto the surfaces of the crystals. The crystals become arranged into stacks which are held together electrostatically by sharing of sodium ions in the interlayer region between adjacent crystals. At 25° C. in tap water and with rapid agitation, this process is substantially complete after 10 minutes. High shear mixing, elevated temperature or chemical dispersants are not required. A dilute dispersion of Laponite in deionised water may remain a low viscosity dispersion of non-interacting crystals for long periods of time. The crystal surface has a negative charge of 50 to 55 mmol·100^{g-1}. The edges of the crystal have small localised positive charges generated by absorption of ions where the crystal structure terminates. This positive charge is typically 4 to 5 mmol·100^{g-1}. The addition of polar compounds in solution (e.g. simple salts, surfactants, coalescing solvents, soluble impurities and additives in pigments, fillers or binders etc.) to the dispersion of Laponite will reduce the osmotic pressure holding the sodium ions away from the particle surface. This causes the electrical double layer to contract and allows the weaker positive charge on the edge of the crystals to interact with the negative surfaces of adjacent crystals.

The process of the present invention may provide a “house of cards” structure which, in a simple system of Laponite, water and salt, is seen as a highly thixotropic gel. This gel consists of a single flocculated particle held together by weak electrostatic forces.

The water swellable laponite clay used in the process of the present invention may be in powder form and may be used in an amount of at least 0.04 weight %. Preferably the water swellable laponite clay may be used in an amount of at least 0.05 weight %. More preferably the water swellable laponite clay may be used in an amount of at least 0.06 weight %.

In addition, the water swellable clay is preferably present in an amount of no more than 3.5 weight %. More preferably the water swellable clay is present in an amount of no more than 2.5 weight %. Most preferably the water swellable clay is present in an amount of no more than 0.6%-1% weight %.

Laponite EL clay is a preferred structurant for use with citrus pulp containing formulations as in process of the present invention as the clay allows access to lower citrus pulp formulations by using the clay as a co-structurant.

6. Liquid Detergent Formulations

The detergent formulations prepared in the process of the present invention have sufficient yield stress, also called critical stress, of at least 0.08 Pa. Preferably the detergent formulations have a yield stress of at least 0.09 Pa. More preferably the detergent formulations have a yield stress of at least 0.1 Pa, and even at least 0.15 Pa measured at 25° C. These increasing levels of yield stress are capable of suspending particles of increasingly different density from the bulk liquid. A yield stress of 0.09 Pa has been found sufficient to suspend most types of perfume encapsulates. Most preferred yield stress for detergent formulations is 0.3 Pa-1.0 Pa.

The detergent liquid may be formulated as a concentrated detergent liquid for direct application to a substrate, or for application to a substrate following dilution, such as dilution before or during use of the liquid formulation by the consumer or in washing apparatus.

Cleaning may be carried out by simply leaving the substrate in contact for a sufficient period of time with a liquid medium constituted by or prepared from the liquid cleaning formulation. Preferably, however, the cleaning medium on or containing the substrate is agitated.

Brighteners

Any optical brighteners or other brightening or whitening agents known in the art may be incorporated at levels typically from about 0.05% to about 1.2%, by weight, into the liquid detergent formulations.

Commercial optical brighteners, which may be useful in the present invention, may be classified into subgroups, which include, but are not necessarily limited to: derivatives of stilbene, pyrazoline, cournarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Dye Transfer Inhibiting Agents.

The formulations prepared according to the process of the present invention may also include one or more materials for inhibiting the transfer of dyes from one fabric to another during the cleaning process. Generally, such dye transfer inhibiting agents are selected from the groups consisting of: polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from 0.01% to 10 weight % of the formulation. Preferably the agents comprise from 0.01% to 5 weight %. More preferably the agents comprise from 0.05% to 2 weight %.

Bleaches

Optionally, the formulation according to the present invention may contain a bleach or bleach system. This bleach or bleach system may be, for example: (a) a peroxygen bleach species alone and/or in combination with a bleach activator and/or a transition metal catalyst; and (b) a transition metal catalysts in a formulation substantially devoid of peroxygen species. Bleaching catalysts for stain removal have been developed over recent years and may be used in the process of the present invention. Examples of transition metal bleaching catalysts that may be used are found, for example, in: WO01/48298, WO00/60045, WO02/48301, WO-00/29537 and WO00/12667. The catalyst may alternatively be provided as the free ligand that forms a complex in situ.

Since many bleaches and bleach systems are unstable in aqueous liquid detergents and/or interact unfavourably with other components in the formulation, for example enzymes, these bleach systems may for example be protected, for example, by encapsulation or by formulating a structured liquid formulation, whereby the compounds are suspended in solid form. Photobleaches, including singlet oxygen photobleaches, may also be used.

Product Form

The liquid detergent formulations obtainable by the method according to the present invention are preferably concentrated liquid cleaning formulations. The liquid formulations have a physical form, which ranges from a pourable liquid, a pourable gel to a non-pourable gel. These forms are conveniently characterised by the product viscosity. In these definitions, and unless indicated explicitly to the contrary, throughout this specification, all stated viscosities are those measured at a shear rate of 21 s⁻¹ and at a temperature of 25° C. This shear rate is the shear rate that is usually exerted on the liquid when poured from a bottle. The liquid detergent formulations made according to the invention are shear-thinning liquids.

Pourable liquid detergent formulations preferably have a maximum viscosity of 2000 mPas quoted at 21 1/s. More preferably liquid detergent formulations have a viscosity of not more than 1500 mPa·s. Still more preferably, liquid detergent formulations have a viscosity of not more than 1000 mPa·s.

Liquid detergent formulations which are pourable gels, preferably have a viscosity of at least 1,000 mPa·s but no more than 6,000 mPa·s. More preferably liquid detergent formulations which are pourable gels, have a viscosity of no more than 4,000 mPa·s. Still more preferably liquid detergent formulations which are pourable gels have a viscosity of no more than 3,000 mPa·s and especially no more than 2,000 mPa·s.

Non-pourable gels preferably have a viscosity of at least 6,000 mPa·s but no more than 12,000 mPa·s. More preferably non-pourable gels have a viscosity of no more than 10,000 mPa·s. Still more preferably non-pourable gels have a viscosity of no more than 8,000 mPa·s and especially not more than 7,000 mPa·s.

For the purpose of the invention a formulation is considered physically stable when it remains homogeneous with dispersed and suspended perfume encapsulates over a period of 3 months at temperatures from 5 to 25° C. and over a period of 2 months at temperatures at 37° C.

By concentrated, is meant low dosage levels of detergent applied to the wash. Typical dosages for concentrated liquids are between 30 and 45 ml, more preferably 35 to 40 ml, most preferably, 35 ml. Surfactant concentrations may typically range from: 10 to 60% total surfactant; more preferably 15 to 40% total surfactant; most preferably between 20% and 30% total surfactant.

Optional Ingredients

Activated citrus fibre and water swellable clay has been found to be compatible with usual ingredients that may be found in detergent liquids. Among which there may be mentioned, by way of example: polymeric thickeners; enzymes, particularly: lipase, cellulase, protease, mannanase, amylase and pectate lyase; cleaning polymers, including ethoxylated polyethylene imines (EPEI) and polyester soil release polymers; chelating agents or sequestrants, including HEDP (1-Hydroxyethylidene-1,1,-diphosphonic acid) which is available, for example, as Dequest® 2010 from Thermphos; detergency builders; hydrotropes; neutralising and pH adjusting agents; optical brighteners; antioxidants and other preservatives, such as antimicrobial agents including Proxel®; other active ingredients, processing aids, dyes or pigments, carriers, fragrances, suds suppressors or suds boosters, chelating agents, clay soil removal/anti-redeposition agents, fabric softeners, dye transfer inhibition agents, and transition metal catalyst in a formulation substantially devoid of peroxygen species.

These and further possible ingredients for inclusion in the present invention are further described in WO 2009/153184 and are incorporated herein by reference.

Packaging

The formulations may be packaged in any form of container. Typically a plastic bottle with a detachable closure/pouring spout. The bottle may be rigid or deformable. A deformable bottle allows the bottle to be squeezed to aid dispensing. If clear bottles are used they may be formed from PET. Polyethylene or clarified polypropylene may be used. Preferably the container is clear enough that the liquid, with any visual cues therein, is visible from the outside. The bottle may be provided with one or more labels, or with a shrink wrap sleeve which is desirably at least partially transparent, for example 50% of the area of the sleeve may be transparent. The adhesive used for any transparent label should not adversely affect the transparency.

### EXAMPLES

The invention will now be further described with reference to the following non-limiting examples and accompanying drawings in which:

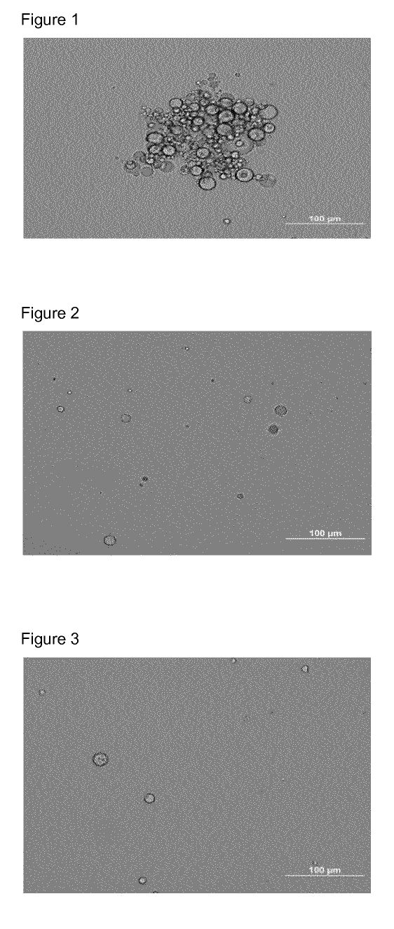

FIG. 1—is a photograph of a detergent liquid formulation from experiment 1B viewed through a microscope in which microcapsules have been added to the formulation as a concentrated slurry at the end of the formulation process that is, after the milling stage and illustrates agglomeration of the microcapsules.

FIG. 2—is a photograph of a detergent liquid formulation from experiment 10 viewed through a microscope in which a dispersion of microcapsules has been formed and added to the formulation at the end of the formulation process, after the milling step and illustrates no agglomeration of the microcapsules.

FIG. 3—is a photograph of a detergent liquid formulation from experiment 1A viewed through a microscope in which a dispersion of microcapsules has been formed in batch water and added to the formulation at the start of the formulation process and illustrates no agglomeration of the microcapsules.

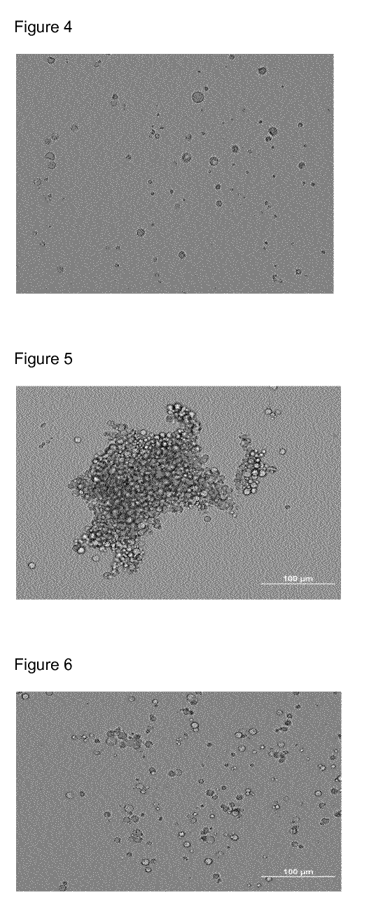

FIG. 4—is a photograph of a detergent liquid formulation from experiment 2A comprising Type 2 (Dual) encapsulates and illustrates no agglomeration of the microcapsules when added at the start of the formulation process with batch water.

FIG. 5—a photograph of a detergent liquid formulation from experiment 2B comprising Type 2 (Dual) encapsulates and illustrates agglomeration of the microcapsules when added neat to the formulation after the milling stage.

FIG. 6—a photograph of a detergent liquid formulation from experiment 2C comprising Type 2 (Dual) encapsulates and illustrates minimal agglomeration when the microcapsules are pre-dispersed in 50:50 mixture of slurry:water.

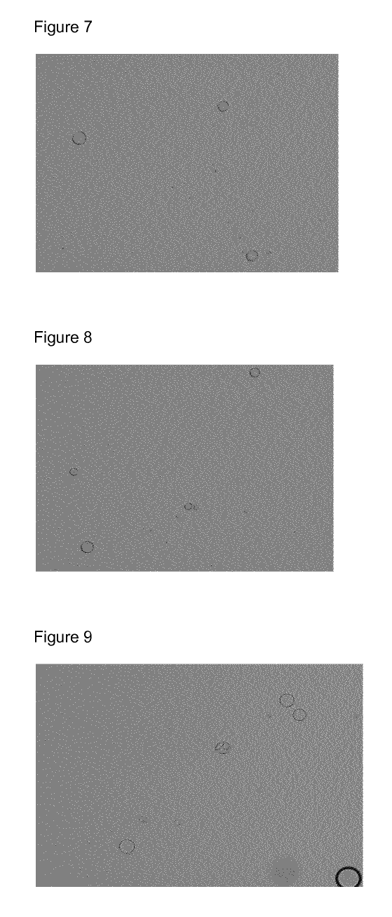

FIG. 7—is a photograph of a detergent liquid formulation from experiment 3A comprising cationic encapsulates and illustrates no agglomeration of the microcapsules when same are added up-front with batch water.

FIG. 8—is a photograph of a detergent liquid formulation from experiment 3B comprising cationic encapsulates and illustrates no agglomeration of the microcapsules when added as a 50:50 pre-dispersion with water and when added at the end of the formulation process.

FIG. 9—is a photograph of a detergent liquid formulation from experiment 4A comprising HPC encapsulates and illustrates no agglomeration of the HPC microcapsules when added upfront at the start of the formulation process with batch water.

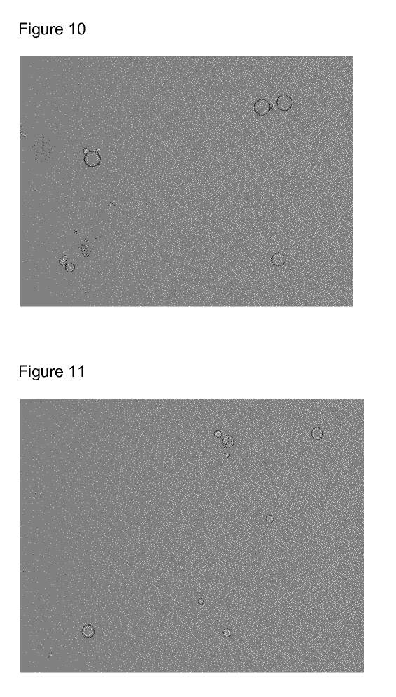

FIG. 10—is a photograph of a detergent liquid formulation from experiment 4B comprising HPC encapsulates and illustrates no agglomeration of the HPC microcapsules when pre-dispersed in 50:50 slurry:water mixture and post-dosed into the formulation.

FIG. 11—is a photograph of a detergent liquid formulation from experiment 5A comprising non-coated encapsulates and illustrates no agglomeration of microcapsules when added up-front in batch water.

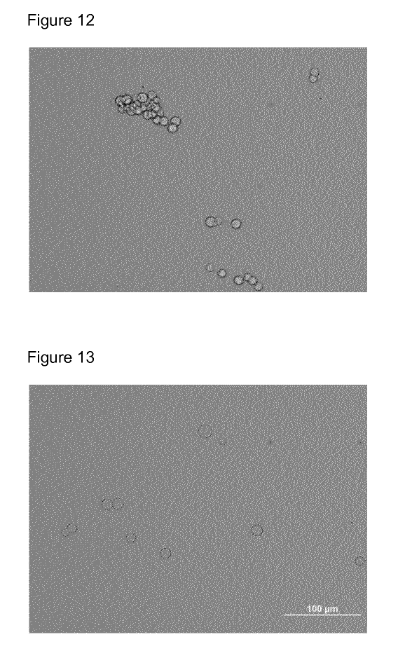

FIG. 12—is a photograph of a detergent liquid formulation from experiment 5B comprising non-coated encapsulates and illustrates agglomeration of the microcapsules when pre-dispersed in 50:50 slurry:water mixture.

FIG. 13—is a photograph of a detergent liquid formulation from experiment 5C comprising non-coated encapsulates and illustrates no agglomeration of the microcapsules when pre-dispersed in a 1:3 slurry:water mixture and then post-dosed into the formulation.

### ABBREVIATIONS

The following abbreviated names used in the examples have the following meanings:
ACF is high pressure homogenizer (HPH) activated citrus fibre (2 weight % premix).
Water is Demineralised water.
Glycerol is hydrotrope.
MPG is Monopropylene Glycol (hydrotrope).
Neodol NI is a nonionic surfactant (NI) ex Shell
NaOH is 50% sodium hydroxide base.
LAS acid is linear alkyl benzene sulphonic acid anionic surfactant.
MEA is Monoethanolamine base
TEA is Triethanolamine base
Prifac 5908 is saturated fatty acid (soap) ex Croda
SLES (3EO) is SLES 3EO anionic surfactant.
Dequest 2066 is Diethylenetriamine penta(methylene phosphonic acid (or Heptasodium DTPMP) sequestrant ex Thermphos.
Dequest 2010 is HEDP (1-Hydroxyethylidene-1,1,-diphosphonic acid) sequestrant ex Thermphos
EPEI is ethoxylated polyethyleneimine PE1600E020 Sokalan HP20 ex BASF
HPH High pressure homogenizer
Neolone MIT 950™ is antimicrobial preservative, methylisothiazolin-3-one in water ex Dow chemical
Perfume encaps is encapsulated perfume, for example, Oasis Cap Det B72 ex Givaudan.
Polynesie is a fragrance oil
Preservative is Proxel GXL™ antimicrobial preservative, 20% solution of 1,2 benzisothiazolin-3-one in dipropylene glycol and water ex Arch Chemicals.
Perfume is free oil perfume
Laponite EL is water swellable synthetic hectorite clay ex Rockwood
Laponite RD is water swellable synthetic hectorite clay ex Rockwood
Micro is ISP white microbeads (visual cues).
Viscolam CK57 is a cross-linked thickening polymer ex Lamberti
Tinopal 5BM—GX is a fluorescer ex BASF
Kleen is an encapsulated fragrance
Xpect®1000L is pectate lyase ex Novozymes
Protease is Relase Ultra 16L EX ex Novozymes
L blend is a blend of 3 parts Stainzyme (amylase) to 1 part Mannaway (mannanase) ex Novozymes
Savinase is Ultra 16L—an enzyme Ex Novozymes
Liquitint a dye
NI non-ionic

Experimental

Five experiments were performed to investigate how different types of microcapsules in the form of encapsulated perfumes (or ‘encaps’) behave in a liquid detergent formulation depending on the order of addition of the encapsulated perfumes with respect to other reagents.

The experiments involved two different formulations and five different types of encapsulated perfumes. The encapsulated perfumes were added at two different times during the preparation of the detergent formulation, namely, at the start of the formulation process that is, ‘up-front’ addition of the microcapsules, or at the end of the formulation process, referred to as “post-dosed” addition of the microcapsules. In addition, the microcapsules were added as a concentrated slurry or as a pre-dispersed solution as described in premix A.

The five different experiments were therefore:
Experiment 1: Formulation 1 with encapsulated perfume of type 1.
Experiment 2: Formulation 1 with encapsulated perfume of type 2.
Experiment 3: Formulation 2 with encapsulated perfume of type 3.
Experiment 4: Formulation 2 with encapsulated perfume of type 4.
Experiment 5: Formulation 2 with encapsulated perfume of type 5.

### Form of the Five Different Microcapsules Used in Experiments 1 to 5:

1. Encapsulated perfume of type 1—a slurry of an uncharged/non-ionic melamine formaldehyde resin polymer shell incorporated with a xyloglucan (XG) (non-ionic polysaccharide) deposition aid.
2. Encapsulated perfume of type 2—a slurry comprising Type 2 dual encaps, that is, a mixture of 2 different encapsulated microcapsules, a first encap, Encap A comprising a melamine formaldehyde resin polymer shell which has incorporated within, an xyloglucan (XG) (a non-ionic polysaccharide) deposition aid; and Encap B comprising a melamine formaldehyde resin polymer shell, modified to be porous or “leaky” in a wash, with no deposition aid.
3. Encapsulated perfume of type 3—an encapsulated microcapsule slurry comprising a melamine formaldehyde resin polymer shell which has incorporated within, a cationic guar gum deposition aid, ex Firmenich.
4. Encapsulated perfume of type 4—an encapsulated microcapsule slurry comprising a melamine formaldehyde resin polymer shell which has incorporated within, Hydroxy propyl cellulose (HPC), a non-ionic polysaccharide substantive to cellulose and polyester.

5. Encapsulated perfume of type 5—an encapsulated microcapsule slurry comprising a melamine formaldehyde resin polymer shell which does not have any deposition aids grafted into the shell (classed as a “bare” or non-coated encap).

### Premix A—Preparation of Dispersed Microcapsules (Encapsulated Perfumes).

The microcapsules used in the experiments encapsulate a fragrance and comprise a melamine formaldehyde shell, with either an outer cationic charge or an outer anionic charge. The microcapsules are supplied as a concentrated slurry in water. In accordance with the present invention the microcapsules were further diluted with an equivalent or greater weight of water and agitated with stirring for 5 minutes to form a diluted or pre-dispersed slurry (where a 50:50 dilution was not sufficient to disperse the microcapsule encap, a premix of 1:3 slurry:water was used). The slurry of microcapsules was either diluted with demineralised water or with demineralised water and batch water supplied with other components to achieve the required final weight of water in the formulation.

Premix B—Preparation of Activated Citrus Fibre

An activated 2 Kg citrus fibre premix was prepared which involved the preparation of a citrus powder/water premix comprising citrus fibre powder (Herbacel AQ plus N Citrus Fibre (ex: Herbafoods)), for example 2 weight %, as the external structurant as set out in Table 1.

TABLE 1

| Material | % As supplied | Weight (g) |
|---|---|---|
| De-mineralised water | 97.92 | 1958.4 |
| Proxel GXL ™ | 0.08 | 1.6 |
| Herbacel AQ + type N | 2 | 40 |

The citrus pulp was added slowly to a mixture of de-mineralised water and preservative, Proxel GXL™ and the reactants stirred with agitator with overhead drive operated at 200 rpm for 15 minutes ensuring that clumping did not occur. This allowed the fibres to hydrate sufficiently prior to activation. The citrus pulp powder/water premix was then processed using a high pressure homogenizer (HPH) (200) to activate the citrus pulp fibres. That is, the solubilised citrus pulp powder was homogenized at around 500 barg and at a flow rate of 11 kg/hour using an APV2000 laboratory high pressure homogenizer available from SPX.

### Preparation of Generic Formulation Mixture.

Separately, a formulation was prepared in which clay for example 0.1 weight % was mixed together with de-mineralised water as required with stirring at 300 rpm for 15 minutes. The stirring rate of the clay formulation was then reduced to 250 rpm before adding activated citrus pulp premix. The citrus pulp and clay mixtures were then mixed together for 5 minutes.

As appropriate, sufficiently fresh activated citrus fibre/clay premix was added to the mixer to provide the required level of activated citrus fibre in the finished detergent formulation prior to milling.

Demineralised water (as defined in Table 2), clay and citrus pulp (premix B), were combined with stirring, the stirring rate of the citrus fibre and clay premix was set to 200 rpm and the remaining formulation components as defined in Table 2 were added except for encapsulated fragrance microcapsules (Premix A).

In experiments where the encapsulated fragrance microcapsules (encaps) were added “up-front”, that is, at the start of the preparation of the detergent formulation mixture, the microcapsules were added in concentrated slurry format directly to the formulation batch before addition of the citrus pulp and clay. The formulation (which may or may not include encapsulated fragrance microcapsules, depending on the experimental encap order of addition) was then mixed for 15 to 20 minutes. The formulation was then passed through an in-line high shear rotar stator mixer operating at between 1.2 and 5.0 kJ/Kg energy. A specific energy of between 1.2 and 5.0 kJ/Kg provides a suitable operating window for consistent structurant dispersal of the detergent components.

The components in the detergent formulation were added in the order set out in Table 2 in which ‘as 100%’ defines the amount of reagent required in final the formulation based on 100% reagent supplied.

TABLE 2

| | AS 100% | WEIGHT |
|---|---|---|
| REAGENT | ACTIVE | (g) |
| Demineralised (batch) water** | 58.451 | 490.18 |
| Non-clay microcapsules in the form of | 0.300 | 3.00 |
| encapsulated fragrance | | |
| 2% Citrus Pulp | 0.100 | 50.00 |
| Laponite Clay powder | 0.200 | 2.00 |
| Fluorescer (brightening agent) | 0.080 | 1.18 |
| Tinopal 5BM-GX | | |
| MPG (hydrotrope) | 2.000 | 20.00 |
| Glycerol(hydrotrope) | 5.000 | 50.00 |
| NaOH (neutralizer) | 1.200 | 25.53 |
| TEA (neutralizer, buffer, hydrotrope) | 1.690 | 17.07 |
| Neodol 25_79 (non-ionic surfactant) | 13.720 | 137.20 |
| LAS acid (anionic surfactant) | 9.150 | 94.23 |
| Prifac 5908/Palmera B1231(fatty acid) | 1.500 | 15.00 |
| SLES 3EO (anionic surfactant) | 4.570 | 65.29 |
| Dequest 2066 (sequestrant) | 0.340 | 10.63 |
| Proxel ™ GXL (preservative) | 0.02 | 1.00 |
| Neolone MIT 950(preservative) | 0.0095 | 1.00 |
| Perfume fragrance | 0.92 | 9.20 |
| Enzymes | 0.75 | 7.50 |
| Total | 100% | 5000.00 |

**Amount includes water derived from reagents in the formulation.

Experiment 1

Formulation (1) (as a 30% active formulation)—a first formulation was prepared comprising the components in Table 2 above using an encapsulated fragrance of type 1. The type 1 encapsulated fragrance comprised a melamine formaldehyde shell with a Xyloglucan outer coating deposition aid. The type 1 encapsulated fragrance was added to the detergent formulation as follows:

Experiment 1A: encapsulated fragrance added upfront to the demineralised (batch) water;

Experiment 1B: encapsulated fragrance post-dosed at the end of the preparation after milling of the detergent formulation as a concentrated slurry; or

Experiment 1C: encapsulated fragrance post-dosed at the end of the preparation of the detergent formulation after milling as a pre-dispersed 50:50 premix (A) in demineralised/batch water.

The resulting formulations were then observed under a microscope in order to investigate and assess the agglomeration of the encapsulated fragrance (encaps).

The results from experiments 1A, 1B and 10 demonstrated that for encapsulated fragrance with a xyloglucan outer coating deposition aid, if added in a concentrated format after the formulation has been milled, the encapsulated fragrance agglomerated, as depicted in FIG. 1. However, addition of the encapsulated fragrance in either the demineralised (batch) water (Experiment 1A, FIG. 3), or pre-dispersed and post-dosed at the end of the preparation of the detergent formulation after milling (Experiment 10, FIG. 2), did not lead to agglomeration of the encapsulated fragrance microcapsules.

Therefore, Experiments 1A, 1B and 10 demonstrate that pre-dispersal of the encapsulated fragrance in water enables the encapsulated fragrance to be added at the start or the end of the batch process.

Experiment 2

For Experiment 2, Experiment 1 was repeated using the formulation detailed in Table 2.

The encapsulated fragrance was replaced however with an alternative encapsulated fragrance namely, an encapsulated perfume slurry comprising Type 2 dual encaps, that is, a mixture of 2 different encapsulated microcapsules, a first encap, Encap A comprising a melamine formaldehyde resin polymer shell which has incorporated within, a xyloglucan (XG) (a non-ionic polysaccharide) deposition aid; and Encap B comprising a melamine formaldehyde resin polymer shell, modified to be porous or “leaky” in a wash, with no deposition aid.

The Type 2 encapsulated fragrance was added to the detergent formulation as follows:

Experiment 2A: encapsulated fragrance added up-front in demineralised (batch) water;

Experiment 2B: encapsulated fragrance post-dosed at the end of the preparation of the detergent formulation as a concentrated slurry; or

Experiment 2C: encapsulated fragrance post-dosed at the end of the preparation of the detergent formulation as a pre-dispersed 50:50 premix (A) in demineralised (batch) water.

The resulting formulations were then observed under a microscope in order to investigate and assess the agglomeration of the encapsulated fragrance (encaps).

The results from experiments 2A, 2B and 2C again demonstrated that for the Type 2 encapsulated fragrance with and without a xyloglucan outer coating deposition aid, if added in a concentrated format after the formulation has been milled, the encapsulated fragrance agglomerates, as depicted in FIG. 5 (Experiment 2B). However, addition of the encapsulated fragrance in either the demineralised (batch) water (Experiment 2A, FIG. 4), or pre-dispersed in water and post dosed at the end of the preparation of the detergent formulation after milling (Experiment 2C, FIG. 6), does not lead to unacceptable levels of agglomeration of the encapsulated fragrance microcapsules. Therefore, Experiments 2A, 2B and 2C also demonstrate that pre-dispersal of encapsulated fragrance in water enables the encapsulated fragrance to be added at the start or the end of the formulation process.

Experiment 3

For experiments 3 to 6 a second formulation, Formulation (2), (as a 23% active formulation) was prepared comprising the components in Table 3 below but using three different encapsulated fragrances described as types 3 to 5 respectively.

TABLE 3
Example of 1 Kg batch of Formulation 2

| | | WEIGHT |
|---|---|---|
| REAGENT | AS 100% ACTIVE | (g) |
| Demineralised (batch) water | 58.4 | 480 |
| Non-clay microcapsules in the form of | 0.4 | 13.7 |
| encapsulated fragrance, type 3, 4 or 5 | | |
| 2% Citrus Pulp | 0.1 | 50 |
| Laponite Clay powder | 0.2 | 2 |
| Fluorescer (brightening agent) | 0.08 | 1.18 |
| Tinopal 5BM-GX | | |
| MPG (hydrotrope) | 2 | 20 |
| Glycerol(hydrotrope) | 5 | 50 |
| NaOH (neutralizer) | 1.2 | 25.5 |
| TEA (neutralizer, buffer, hydrotrope) | 1.69 | 17.1 |
| Neodol 25_79 (non-ionic surfactant) | 13.72 | 137.2 |
| LAS acid (anionic surfactant) | 9.15 | 94.2 |
| Prifac 5908/ | 1.5 | 15 |
| Palmera B1231 (fatty acid) | | |
| SLES 3EO (anionic surfactant) | 4.57 | 65.3 |
| Dequest 2066 (sequestrant) | 0.34 | 10.63 |
| Proxel ™ GXL (preservative) | 0.02 | 1.0 |
| Neolone MIT 950 (preservative) | 0.0095 | 1.0 |
| Perfume fragrance | 0.86 | 8.6 |
| Enzymes | 0.75 | 7.5 |
| Total | 100 | 1000 |

For experiment 3, a type 3 encapsulated microcapsule slurry fragrance was used which comprised a melamine formaldehyde resin polymer shell which had incorporated within, a cationic guar gum deposition aid, ex Firmenich.

The type 3 encapsulated fragrance was added to the detergent formulation as follows:

Experiment 3A: encapsulated fragrance added up-front in demineralised (batch) water;

Experiment 3B: encapsulated fragrance post-dosed at the end of the preparation of the detergent formulation as a pre-dispersed 50:50 premix (A) in demineralised (batch) water.

The resulting formulations were then observed under a microscope in order to investigate and assess the agglomeration of the encapsulated fragrance (encaps).

The results from experiments 3A and 3B demonstrated that for a cationic coated encapsulated fragrance addition of the encaps either to the demineralised (batch) water (Experiment 3A, FIG. 7), or pre-dispersed and post-dosed at the end of the preparation of the detergent formulation after milling (Experiment 3B, FIG. 8), does not lead to agglomeration of the encapsulated fragrance microcapsules.

Therefore, Experiments 3A and 3B also demonstrate that pre-dispersal of the encapsulated fragrance in water enables the encapsulated fragrance to be added at the start or the end of the formulation process.

Experiment 4

For Experiment 4, Experiment 3 was repeated using the formulation detailed in Table 3 except that the encapsulated fragrance was replaced with type 4 encapsulated fragrance microcapsule slurry comprising a melamine formaldehyde resin polymer shell which had incorporated within, hydroxypropyl cellulose (HPC), a non-ionic polysaccharide deposition aid or coating substantive to cellulose and polyester.

The type 4 encapsulated fragrance microcapsules were added to the detergent formulation as follows:

Experiment 4A: encapsulated fragrance added up-front in demineralised (batch) water;

Experiment 4B: encapsulated fragrance post-dosed as a 50:50 premix A.

The resulting formulations were then observed under a microscope in order to investigate and assess the agglomeration of the encapsulated fragrance (encaps), Experiment 4A, FIG. 9 and Experiment 4B, FIG. 10 respectively.

The results from experiments 4A, and 4B demonstrated that for the type 4 encapsulated fragrance with a HPC (hydroxylpropyl cellulose) deposition aid or coating, this encapsulated fragrance did not lead to agglomeration of the encapsulated fragrance microcapsules either when added with the demineralised (batch) water or when post-dosed as a 50:50 premix A.

Experiment 5

For Experiment 5, Experiment 3 was repeated using the formulation detailed in Table 3 using an alternative type 5 encapsulated fragrance microcapsule slurry comprising a melamine formaldehyde resin polymer shell without any deposition aids grafted into the shell (classed as a “bare” or non-coated encapsulate).

The type 5 encapsulated fragrance was added to the detergent formulation as follows:

Experiment 5A: encapsulated fragrance added up-front in demineralised (batch) water;

Experiment 5B: encapsulated fragrance post-dosed as a 50:50 premix A.

Experiment 5C: encapsulated fragrance post-dosed as a pre-dispersed 1:3 slurry:water ratio premix.

The resulting formulations were then observed under a microscope in order to investigate and assess the agglomeration of the encapsulated fragrance (encaps), Experiment 5A FIG. 11, Experiment 5B, FIG. 12 and Experiment 5C, FIG. 13 respectively.

The results from experiments 5A, and 5B demonstrated that for the type 5 encapsulated fragrance with no deposition aid or coating, this encapsulated fragrance does not lead to agglomeration of the encapsulated fragrance microcapsules either when added with the demineralised (batch) water or when post dosed as a pre-dispersed 1:3 slurry:water ratio premix after milling.

Therefore, in summary, the results of the five groups of experiments show that that if microcapsules with encapsulated perfumes are dispersed either in aqueous media such as for example, demineralised (batch) water, or alternatively, in a ratio of least 1:3 encapsulated microcapsule to aqueous solution, the encapsulated perfume may be added ‘up-front’ with formulation demineralised (batch) water or post-dosed to the formulation, without agglomeration of the microcapsules. That is, it is possible to avoid the agglomeration of microcapsules normally observed on post-addition of a concentrated slurry of microcapsules.

Microscope Images and Analysis

As indicated above photographs were taken of each liquid detergent formulation prepared with microcapsules treated and added to the liquid detergent at different points in the preparation of the formulation.

The photographic images seen in FIGS. 1 to 13 were acquired using a BX51 Olympus microscope fitted with a Marzhauser motorised stage, fitted with a Zeiss HRc

Axiocam camera controlled by Zeiss Axiovision software.

For each detergent liquid formulation, a sample of the detergent was isolated and contained within a cavity slide which in turn was sealed with a coverslip. The images of the liquid detergent formulations were recorded in transmission DIC mode at times twenty 20 magnification producing images with a lateral resolution of 0.65 um and a field of view of 446×335 um.

Summary of Results

TABLE 4

| Exper- | | Encap | | |
|---|---|---|---|---|
| iment | | Order of | Observation | Figure |
| Number | Description | addition | after Milling | Number |
| 1A | Neat XG encaps | Upfront | No agglomeration | 3 |
| 2A | Neat Dual encaps | Upfront | No agglomeration | 4 |
| 3A | Neat Cationic | Upfront | No agglomeration | 7 |
| | encaps | | | |
| 4A | Neat HPC encaps | Upfront | No agglomeration | 9 |
| 5A | Neat Non coated | Upfront | No agglomeration | 11 |
| | encaps | | | |
| 1B | Neat XG encaps | Post dosed | Agglomeration | 1 |
| 1C | Pre-dispersed | Post dosed | No agglomeration | 2 |
| | (50:50) XG encaps | | | |
| 2B | Neat Dual encaps | Post dosed | Agglomeration | 5 |
| 2C | Pre-dispersed | Post dosed | No agglomeration | 6 |
| | (50:50) Dual encaps | | | |
| 3B | Pre-dispersed | Post dosed | No agglomeration | 8 |
| | (50:50) Cationic | | | |
| | encaps | | | |
| 4B | Pre-dispersed | Post dosed | No agglomeration | 10 |
| | (50:50) HPC encaps | | | |
| 5B | Pre-dispersed | Post dosed | Agglomeration | 12 |
| | (50:50) Non-coated | | | |
| | encaps | | | |
| 5C | Pre-dispersed (1:3) | Post dosed | No agglomeration | 13 |
| | Non-coated encaps | | | |

Therefore it may be seen in Table 4 above that agglomeration of microcapsules (such as perfume containing microcapsules) occurs when concentrated microcapsules are added as a final reagent in the preparation of a liquid detergent.

The present inventors have therefore found that agglomeration of microcapsules may be overcome by pre-dispersion of the microcapsules in water prior to addition of the microcapsules to the liquid detergent formulation. The microcapsules may be dispersed in for example, de-mineralized water or alternatively in demineralised water and/or batch water used to formulate the detergent.

However, of interest is the fact that once the microcapsules have been pre-dispersed, it is possible to add the microcapsules at different stages in the preparation of the detergent formulation without encountering agglomeration. In contrast however, if the microcapsules are not pre-dispersed prior to addition to the formulation and the microcapsules are instead added in undiluted concentrated form, agglomeration occurs.

The ability to add microcapsules at different points during the formulation of the detergent liquid provides increased flexibility of the formulation process. In addition, the lack of agglomeration avoids the need for increased agitation of the formulation to ensure dispersion of the microcapsules, which in turns decreases the likelihood that the integrity of the microcapsules will be compromised.

Furthermore, lack of agglomeration of the microcapsules ensures efficient delivery of the microcapsules to fabrics treated with a detergent formulation comprising same following a wash cycle and hence maximized delivery of the contents of the microcapsules, such as for example fragrances.

Therefore in accordance with the present invention it has been observed that it is possible to prepare an externally structured aqueous isotropic liquid laundry detergent formulation in which fragrance encapsulated in microcapsules may be efficiently dispersed throughout the detergent formulation without leading to agglomeration of the microcapsules and without compromising the end delivery of the fragrance held within the microcapsules.

1. A process of manufacturing a structured isotropic aqueous detergent liquid, incorporating microcapsules, the detergent liquid comprising:
i) total surfactant in the range 3 weight % to 70 weight %, and wherein the total surfactant comprises at least 5 weight % anionic surfactant; and
ii) at least 0.05% activated citrus fibre external structurant;
iii) at least 0.001 weight % microcapsules;
the process comprising a step of combining two premixes A and B; wherein:
a) Premix A comprises an aqueous dispersion of microcapsules; and
b) Premix B comprises the structured aqueous concentrated liquid detergent formulation in the absence of microcapsules, characterised in that:
Premix A comprises:
a slurry of microcapsules diluted with at least at an equal weight of water; and
wherein at least 90 weight % of the microcapsules comprise a particle size in the range 1 to 100 microns, preferably from 5 to 30 microns; and
wherein Premix A is agitated with stirring to disperse the microcapsules prior to the addition of Premix A to Premix B; and wherein:
the structured isotropic aqueous liquid detergent comprises less than 5% agglomerated groups of microcapsules, based on the total number of groups of microcapsules, wherein an agglomerated group of microcapsules comprises more than five microcapsules grouped together.

2. A process according to claim 1 wherein the water comprises demineralised water.

3. A process according to claim 1 wherein the microcapsules are charged.

4. A process according to any of the preceding claims wherein the aqueous dispersion of microcapsules in water are added to the structured aqueous concentrated liquid detergent before the addition of all other components of the liquid detergent.

5. A process according to any of the preceding claims wherein the aqueous dispersion of microcapsules in water are added to the structured aqueous concentrated liquid detergent after addition of all other components of the liquid detergent.

6. A process according to claim 5 wherein the aqueous dispersion of microcapsules comprises a 1:1 ratio by weight of microcapsule slurry to water.

7. A process according to claim 5 wherein the aqueous dispersion of microcapsules comprises a 1:3 ratio of microcapsule slurry to water.

8. A process according to any of claims 1 to 7 wherein Premix B is milled with an energy input of from 1.2 to 5.0 KJ/kg prior to mixing with Premix A to form the structured aqueous concentrated liquid detergent.

9. A process according to any of claims 1 to 7 wherein Premix A is combined with Premix B and the two Premixes milled with an energy input of from 1.2 to 5.0 KJ/kg to form the structured aqueous concentrated liquid detergent.

10. A process according to any of claims 1 to 9 wherein the microcapsules comprise an anionic charge.

11. A process according to any of claims 1 to 9 wherein the microcapsules comprise a cationic charge.

12. A process according to any of claims 1 to 9 in which the microcapsules comprise a shell comprising a material selected from the group consisting of: (poly)urea, (poly)urethane, polysaccharide, starch, aminoplasts or a melamine formaldehyde shell.

13. A process according to any of the preceding claims wherein the microcapsules further comprise a deposition aid.

14. A process according to any of claims 1 to 13 wherein the total surfactant is in the range 10 to 40 weight %, most preferably the total surfactant is in the range 20 to 30 weight %.

15. A process according to any preceding claim in which the microcapsules are perfume encapsulates.
